(19) United States
(12) Patent Application Publication
(10) Pub. No.: US 2017/0102346 A1
(43) Pub. Date: Apr. 13, 2017

(54) MEMS Bio-DSC

(71) Applicants: Richard Brown, Norton, MA (US); William Buote, Norton, MA (US); Ernesto Freire, Norton, MA (US); Anthony Maletta, Burlington, MA (US); Thomas Denner, Selb (DE)

(72) Inventors: Richard Brown, Norton, MA (US); William Buote, Norton, MA (US); Ernesto Freire, Norton, MA (US); Anthony Maletta, Burlington, MA (US); Thomas Denner, Selb (DE)

(21) Appl. No.: 14/878,443

(22) Filed: Oct. 8, 2015

(51) Int. Cl. G01N 25/48; B01L 3/00

(52) U.S. Cl. CPC G01N 25/4886; G01N 25/4833; G01N 25/4893; B01L 3/502715; B01L 2300/18; B01L 2300/12; B01L 2300/0627; B01L 2300/0861; B01L 2300/0816; B01L 2200/027; B01L 2200/147; B01L 2300/0609

(57) ABSTRACT

A MEMS cassette for insertion into a DSC calorimeter and a DSC calorimeter using MEMS cassettes to conduct DSC experiments. The MEMS cassette includes a chip configured to conduct DSC reactions of a sample and reference to derive information regarding the sample.

### FIELD OF THE INVENTION

The present application is directed to a MEMS cassette for insertion into a DSC calorimeter and a DSC calorimeter using MEMS cassettes to conduct DSC experiments.

### BACKGROUND OF THE INVENTION

Bio-molecular research is often performed by using Differential scanning calorimetry or DSC. DSC is a label-free thermoanalytical technique in which the difference in the amount of heat required to increase the temperature of a sample and reference is measured as a function of temperature. Both the sample and reference are maintained at nearly the same temperature throughout an experiment and the difference in the amount of heat required is measured by using a sensing device.

For testing the stability of proteins, for example, DSC is used to characterize the stability of a protein or other biomolecule directly in its native form. It does this by measuring the heat change associated with the molecule's thermal denaturation when heated at a constant rate.

For proteins, a biomolecule in solution is in equilibrium between its native (folded) and denatured (unfolded) conformations. The higher the thermal transition midpoint (Tₘ), the more stable the molecule. DSC measures the enthalpy (H) of unfolding that results from heat-induced denaturation. It is also used to determine the change in heat capacity (ΔCₚ) of denaturation. DSC can elucidate the factors that contribute to the folding and stability of native biomolecules. These include hydrophobic interactions, hydrogen bonding, conformational entropy and the physical environment. The precise and high quality data obtained from DSC provides vital information on protein stability in process development, and in the formulation of potential therapeutic candidates.

The DSC technique is widely used across a range of applications, both as a routine quality test and as a research tool. DSC may be used to study oxidation, chemical reactions and phase changes in a sample or sample solution.

Typical information that can be derived from DSC measurements includes: characteristic temperatures (melting, crystallization, polymorphous transitions, reactions, glass transition), melting, crystallization, transformation and reaction heats (enthalpies), crystallinity of semi-crystalline substances, decomposition, thermal stability, oxidative stability (OIT, OOT—oxidative-induction time and oxidation onset temperature, respectively), degree of curing in resins, adhesives, etc., eutectic purity, specific heat (cₚ), compatibility between components, influence of aging, distribution of the molecular weight (peak form for polymers), and impact of additives, softeners or admixtures of re-granulates (for polymer materials).

Other information that can be derived from DSC measurements is tightness of binding of molecules, mechanism of binding, analysis of active material, enzyme kinetics, solution stability and molecular structure.

Existing DSC calorimeter devices include the METTLER-TOLEDO FLASH DSC 1, Nevada Nanotech Systems Self-Sensing Array device, NETZSCH® DSC 214 Polyma, and NETZSCH® DSC 204 F1 PHOENIX® as well as devices such as the PERKIN ELMER® Diamond DSC Differential Scanning calorimeter Furnace w/Chiller and DSC 4000 Standard Single-Furnace Differential Scanning calorimeter, among others in the marketplace.

Existing DSC systems, however, are often large in volume and require a large amount of sample and reference to be tested. Existing systems use a lot of material (200 μL) and are slow in operation (washing, filling, measuring). Existing system do not have high throughput and parallelization is impossible in existing systems. Such deficiencies are significant with regards to protein characterization.

It is therefore desirable to develop a device that requires lower total volume requirements and lower sample requirements than existing systems. It is further desirable to provide a device with the ability to analyze and monitor high protein concentrations (including therapeutic formulations) at higher throughput with greater flexibility and ease of use than existing technologies.

It is further desirable to provide such a device that adequately addresses the needs of bio-molecular research.

### SUMMARY OF THE INVENTION

Accordingly, it is an object of the invention to provide a device that overcomes the disadvantages of the prior art.

It is an object of the invention to provide device that requires lower total volume requirements and lower sample requirements. It is another object to provide a device with the ability to analyze and monitor high protein concentrations (including therapeutic formulations) at higher throughput with greater flexibility and ease of use than existing technologies. It is another object of the invention to provide such a device that adequately addresses the needs of bio-molecular research.

In order to achieve some of the objects of the invention, the presently claimed invention requires Microelectromechanical systems (MEMS) technology. MEMS is the technology of very small devices; it merges at the nano-scale into nanoelectromechanical systems (NEMS) and nanotechnology. MEMS technology is based on fabrication technologies that can realized miniaturization, multiplicity, and microelectronics.

WO 2012/116092 A2 to Qiao Lin and Bin Wang discloses a MEMS calorimeter, fabrication techniques and uses thereof and is an example of MEMS technology for DSC systems. The contents of WO 2012/116092 A2 is hereby incorporated by reference in its entirety into this application.

“A MEMS Differential-Scanning-Calorimetric Sensor for Thermodynamic Characterization of Biomolecules” to Bin Wang and Qiao Lin in the Journal of Microelectromechanical Systems, Vol. 21, No. 5, October 2012 presented a microelectromechanical systems sensor for differential scanning calorimetry of liquid-phase biomolecular samples. The contents of this journal publication is hereby incorporated by reference in its entirety into this application.

The presently claimed invention is directed to a MEMS DSC cassette that is configured to be inserted into a DSC instrument thermal block. In principle, different blocks can be made with the ability to receive one cassette (like a standard DSC) or several (up to 12) cassettes (for multiple samples). In the configurations with several cassettes, if a user uses fewer cassettes than slots in the DSC, dummy cassettes can be used that basically just seal-off the unused positions.

The cassettes have the following advantages in that the cassettes integrate the MEMS chip and the microfluidics, provide for single or parallel use by using one or more cassettes simultaneously, can be disposable or potentially reusable, provide the interface point for a multiplexed data acquisition system, provide a convenient interface to the user, and can integrate other technologies for parallel or serial chemical analysis (absorbance, fluorescence, etc.).

The cassettes enable high measurement throughput at low volumes that make calorimetric screening of large molecular libraries possible. The cassettes use microfluidics, chip sensors, and have high sensitivity. The cassettes can include various arrays of sensors and include wafer technology in that various silicon layers and materials can be used within the cassettes. The cassettes include minimized sample consumption, low cost batch fabrication and high throughput

Furthermore, the MEMS cassettes use a chip that has a small form factor allowing the use of 100-300 times less sample than current technology, as the sample cell is approximately 1 μL in various embodiments of the invention.

Embodiments of the presently claimed invention involve providing a MEMS cassette for insertion into a DSC calorimeter comprising: a housing; and a chip mounted within the housing, the chip including: a first channel extending through the chip; a second channel extending through the chip; a first reaction area located within the first channel; a second reaction area located within the second channel; a thermopile configured to convert thermal energy from the first reaction area and the second reaction area into electrical energy, and at least one heating element, the at least one heating element configured to provide localized heat to the first and second reaction areas to generate a reaction of at least one sample located within the first reaction area and the second reaction area.

Other embodiments of the presently claimed invention involve providing a DSC calorimeter comprising: an instrument block; a temperature scanning unit; an electrical interface; and at least one MEMS cassette, wherein the at least one MEMS cassette is inserted into the instrument block and is in communication with said temperature scanning unit and said electrical interface.

Objects of the invention and its particular features and advantages will become more apparent from consideration of the following drawings and accompanying detailed description. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a front view of a MEMS cassette according to an embodiment of the present invention;

FIG. 2 is a front detailed view of the chip of the MEMS cassette of FIG. 1;

FIG. 3 is a left isometric view of the MEMS cassette of FIG. 1

FIG. 4 is a left isometric view of a MEMS cassette of another embodiment of the invention;

FIG. 5 is a front view of a DSC calorimeter of an embodiment of the present invention;

FIG. 6 is a front view of a DSC calorimeter of another embodiment of the present invention;

FIG. 7 is front view of a DSC calorimeter of another embodiment of the present invention;

FIG. 8 is a plot showing thermopile voltage vs. temperature difference for a thermopile calibration;

FIG. 9 is a plot showing differential voltage v. differential power for a thermopile;

FIG. 10 is a plot showing thermopile voltage v. temperature;

FIG. 11 is a plot showing enthalpy change v. temperature for a thermopile; and

FIG. 12 is a plot showing differential voltage v. temperature for a thermopile.

### DETAILED DESCRIPTION OF THE INVENTION

The present invention is directed to one or more MEMS cassettes configured to be inserted into a DSC device as well as a DSC device that incorporates MEMS cassettes to run DSC experiments for life science research and development, specifically for bio-molecular research.

The advantages of the MEMS cassettes allow for low volume requirements, lower sample requirements and higher throughput for biological macromolecule analytics for life science research and development. The device is specifically tailored for bio-molecular research.

In certain embodiments of the invention, a MEMS cassette for insertion into a DSC calorimeter is provided comprising: a housing; and a chip mounted within the housing, the chip including: a first channel extending through the chip; a second channel extending through the chip; a first reaction area located within the first channel; a second reaction area located within the second channel; a thermopile configured to convert thermal energy from the first reaction area and the second reaction area into electrical energy, and at least one heating element, the at least one heating element configured to provide localized heat to the first and second reaction areas to generate a reaction of at least one sample located within the first reaction area and the second reaction area.

In certain embodiments, the first channel has an inlet and an outlet and the second channel has an inlet and an outlet. In certain embodiments, the first channel has more than one inlet. In certain embodiments the first channel has more than one outlet. In certain embodiments, the second channel has more than one inlet. In certain embodiments the second channel has more than one outlet.

In certain embodiments, the channels are microfluidic chambers or channels. In certain embodiments, the channels are thermally isolated and/or thermally insulated from one another.

In certain embodiments, the channels are configured to provide passive chaotic mixing for a solution or a sample solution flowing through the channels.

In certain embodiments, more than one sample can be provided, each of the samples being provided through each of the inlets into the first and second channels.

In certain embodiments, a sample or sample solution is inserted into the first reaction area and a reference is inserted into the second reaction area. In certain embodiments, the heat given from the sample is compared against the heat given from the reference.

In certain embodiments, the thermopile is configured to measure temperature differential between the first reaction chamber and the second reaction chamber. In certain embodiments, the thermopile is a thin, metal film thermopile. In certain embodiments, the thermopile is fabricated on a silicon substrate or a membrane, such as a parylene membrane. In certain embodiments, the thermocouple elements are formed from Au—Ni microjunctions. In certain embodiments, the thermophile is a thermoelectric sensor. In certain embodiments, the thermopile is made from Antimony-bismuth (Sb—Bi).

In certain embodiments, the at least one heating element includes four individual heating elements. In certain embodiments, two of the heating elements heat the first reaction area and two of the heating elements heat the second reaction area. In certain embodiments, at least a portion of the at least one heating elements are fabricated above or below the first and second reaction areas.

In certain embodiments, the at least one heating element includes a heating circuit, such that a fluid circuit is provided to heat the first reaction area and/or the second reaction area. In certain embodiments, the heating circuit involves using hot fluid to dissipate heat to the first reaction area and/or the second reaction area.

In certain embodiments, the at least one heating element is a heating coil. In certain embodiments, the at least one heating element acts as a heat exchanger. In certain embodiments, the at least one heating element is a microheater.

In certain embodiments, the first reaction area has a larger surface area than the first channel. In certain embodiments, the second reaction area has a larger surface than the second channel. In certain embodiments, the first reaction area has a larger volume than the first channel. In certain embodiments, the second reaction area has a larger volume than the second channel.

In certain embodiments, the first and second reactions areas are identical in volume and configuration and are arranged side by side.

In certain embodiments, the first and second reaction areas are each supported on a thin film substrate.

In certain embodiments, the thin film substrate includes a thermopile sensor located between the first and second reaction chambers and configured to measure the temperature differential between the first and second reaction chambers.

In certain embodiments, the first and second reaction areas are defined by a surrounding wall made from polydimethylsiloxane (PDMS). In certain embodiments, the thin film substrate of the chip can include a top layer made from a mixture of PDMS.

In certain embodiments, the first and second reaction areas are based on a freestanding polyimide diaphragm and surrounded by air cavities for thermal isolation. In certain embodiments, the heating elements are made of a thin-film gold resistive heater.

In certain embodiments, the first and second reaction areas have their temperatures varied at a constant rate.

In certain embodiments, a chemical dye is inserted into the first and the second reaction area, such that the fluorescence of the chemical dye is measured.

In certain embodiments, a chemical reaction occurs in the first reaction area. In certain embodiments, a chemical reaction occurs in the second reaction area.

In certain embodiments, a physical transformation or phase change occurs in the first reaction area. In certain embodiments, a physical transformation or phase change occurs in the second reaction area.

In certain embodiments, the chip is made of silicon or is a silicon wafer. In certain embodiments, the chip includes a thermal substrate bonded to a microfluidic structure.

In certain embodiments, the MEMS cassette is made of a thin film substrate.

In certain embodiments, the cassette housing is made of an outer plastic shell. In certain embodiments, the cassette housing is made of certain plastic materials and plastic polymer materials. In certain embodiments the cassette housing is resistant to heat, such that the cassette housing does not melt at high temperatures (over 350 degrees Fahrenheit).

In certain embodiments, the MEMS cassettes integrate mechanical elements, sensors, actuators, and electronics on a common silicone substrate through microfabrication technology. In certain embodiments, there are resistive temperature sensors and on-chip heaters located within the cassette.

In certain embodiments, the MEMS cassette and chip include a PDMS structure, polymide-PDMS intermediate layer, Sb—Bi thermopile, polymide diaphragm, micro-heater, and temperature sensor on a silicon substrate.

In certain embodiments, the cassette is configured to be electronically plugged into the DSC calorimeter. In certain embodiments, the cassette is directly plugged into the calorimeter and into the thermal block.

In certain embodiments, the cassette is in electrical connection with the DSC calorimeter. In certain embodiments, the cassette is scanned by the DSC calorimeter and DSC reactions occur within the cassette.

In certain embodiments, the cassette is disposable. In certain embodiments, the cassette is reusable and can be sterilized and cleaned.

In certain embodiments, the cassette housing comprises four channels. In certain embodiments, the four channels of the cassette are each in separate communication with a first inlet, second inlet, first outlet and second outlet in the MEMS chip, so that the four channels can transfer fluid into the first inlet and the second inlet and out of the first outlet and the second outlet.

In certain embodiments, the cassette includes a thermal interface, the thermal interface connected to the thermopile, so that the thermal interface measures the amount of electrical energy generated by thermopile. In certain embodiments, the thermal interface includes a sensor or sensing element.

In certain embodiments, the cassette housing has tapered edges at its distal end. In certain embodiments, the cassette housing is substantially rectangular. In certain embodiments, the cassette housing is cylindrical. In certain embodiments, the cassette housing has the shape of an SD card.

In certain embodiments, the cassette housing is substantially rectangular and has a length of 11.0 mm to 32.0 mm and a width of 20.0 mm to 24.00 mm.

Other objects of the invention are achieved by providing a DSC calorimeter comprising: an instrument block; a temperature scanning unit; an electrical interface; and at least one MEMS cassette, wherein the at least one MEMS cassette is inserted into the instrument block and is in communication with said temperature scanning unit and said electrical interface.

In certain embodiments, the DSC calorimeter includes at least two MEMS cassettes.

In certain embodiments, the at least two MEMS cassettes have a structure as set forth above.

In certain embodiments, the instrument block includes six ports, wherein each of the six ports is configured to receive at least one MEMS cassette. In certain embodiments, six MEMS cassettes are provided to correspond to the six ports in the instrument block.

In certain embodiments, the instrument block includes twelve ports, wherein each of the twelve ports is configured to receive at least one MEMS cassette. In certain embodiments, twelve MEMS cassettes are provided to correspond to the twelve ports in the instrument block.

In certain embodiments, the DSC calorimeter includes dummy cassettes, the dummy cassettes configured to be inserted into each of the ports in the DSC calorimeter.

In certain embodiments, the dummy cassettes are inserted into ports that are unoccupied by said MEMS cassettes.

In certain embodiments, the DSC calorimeter includes thermal control unit hardware. In certain embodiments, the DSC calorimeter includes instrument control communications and data collection electronics and firmware design and software.

In certain embodiments, the DSC calorimeter includes a user interface and data processing algorithms.

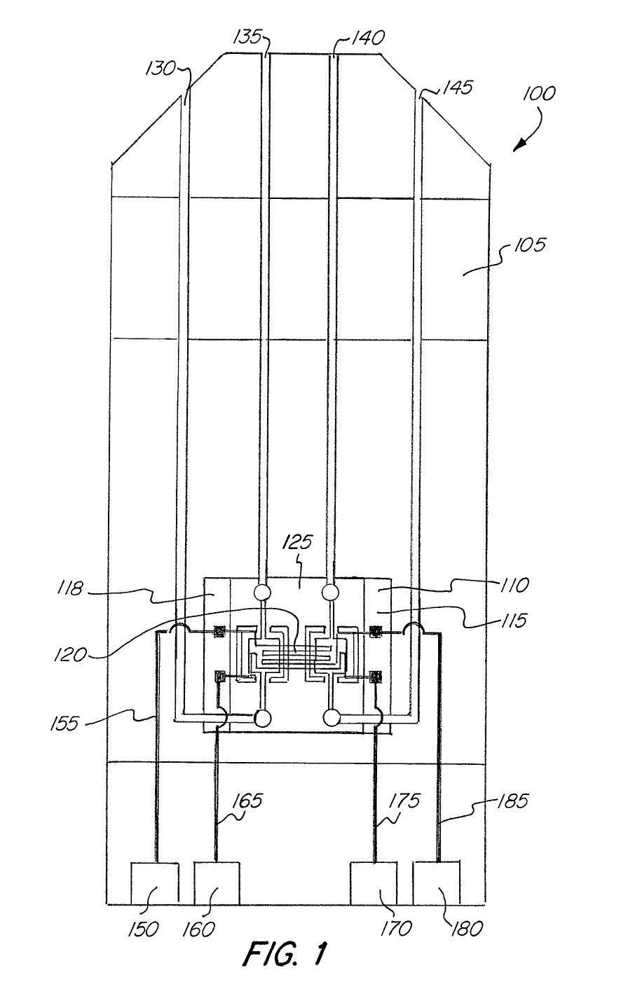

Referring to FIG. 1, a front view of a MEMS cassette 100 is shown. The cassette includes a housing 105 as well as chip 110. The chip is divided into three sections. The middle area 125 supports thermopile 120, and left chip area 118 and right chip area 115 support the heating element(s). The heating elements are shown as elements 150, 160, 170 and 180. The heating elements are connected to heating coils 155, 165, 175 and 185.

In certain embodiments, the left chip area 118 and right chip area 115 is a thin film substrate.

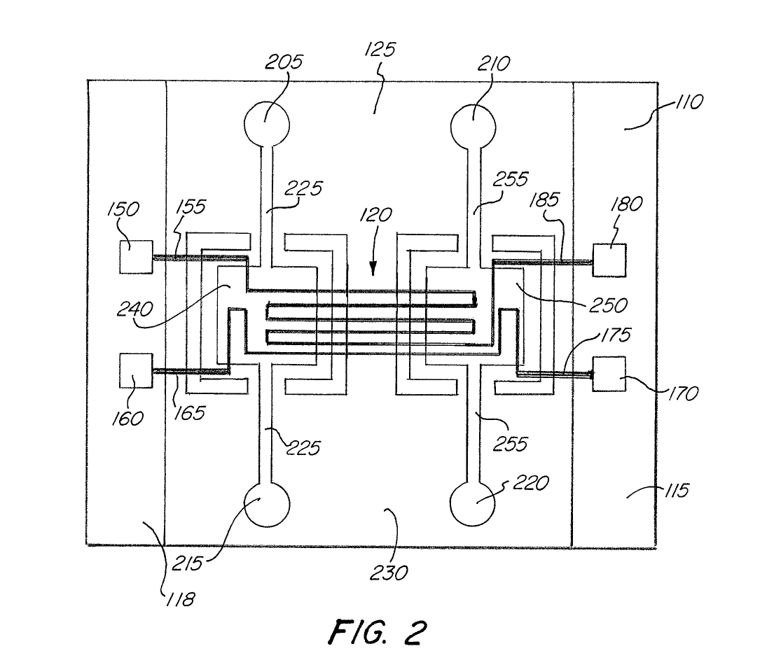

Also shown in FIG. 1 are channels 130, 135, 140 and 145 extending through the cassette housing. Channels 130, 135, 140 and 145 correspond to inlets and outlets in the chip 110, as described in FIG. 2. MEMS cassette 100 is shown being rectangular and having tapered edges.

FIG. 2 is a front detailed view of the chip 110 of the MEMS cassette 100 shown in FIG. 1. The chip includes first inlet 215 and first channel 225 extending through the chip. The first channel 225 includes first reaction area 240, which is shown being interposed within the first channel 225. First outlet 205 is shown at the opposite end of the first channel 225.

FIG. 2 also shows second inlet 220 and second channel 255 extending through the chip. The second channel 255 includes second reaction area 250, which is shown being interposed within the second channel 255. Second outlet 210 is shown at the opposite end of the second channel 255. Also shown in FIG. 2 are the left chip area 118 and right chip area 115 support the heating element(s) as well as thermopile 120. The thermopile 120 measures the difference in heat between reactions occurs in the first reaction area 240 and second reaction area 250.

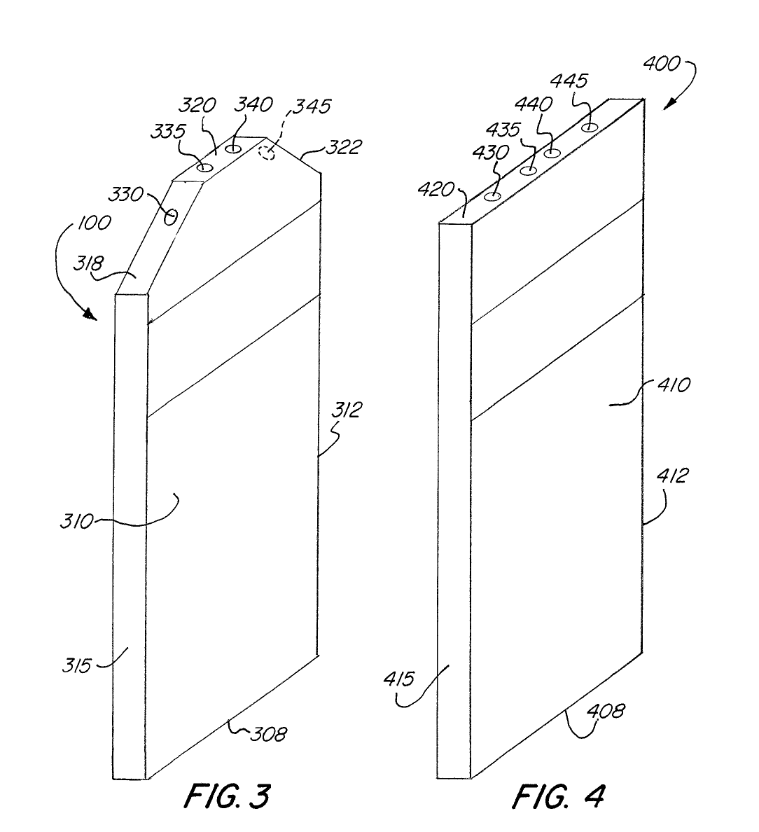

Referring to FIG. 3, left isometric view of the MEMS cassette 100 is shown. The cassette housing has top surface 310, left surface 315, right surface 312 and rear surface 308. The cassette has tapered surfaces 318 and 322 which are connected by surface 320, which is substantially parallel to surface 308 and substantially perpendicular to surfaces 315 and 312. Also shown are inlets 330, 335, 340 and 345, which correspond to channels 130, 135, 140 and 145 respectively.

FIG. 4 is a left isometric view of a MEMS cassette 400. MEMS cassette 400 has top surface 410, left surface 415, right surface 412, rear surface 408 and front surface 420. FIG. 4 also has inlets 430, 435, 440 and 445. The inlet correspond to channels within the cassette housing. A MEMS chip as shown in FIG. 2 is able to be inserted into MEMS cassette 400.

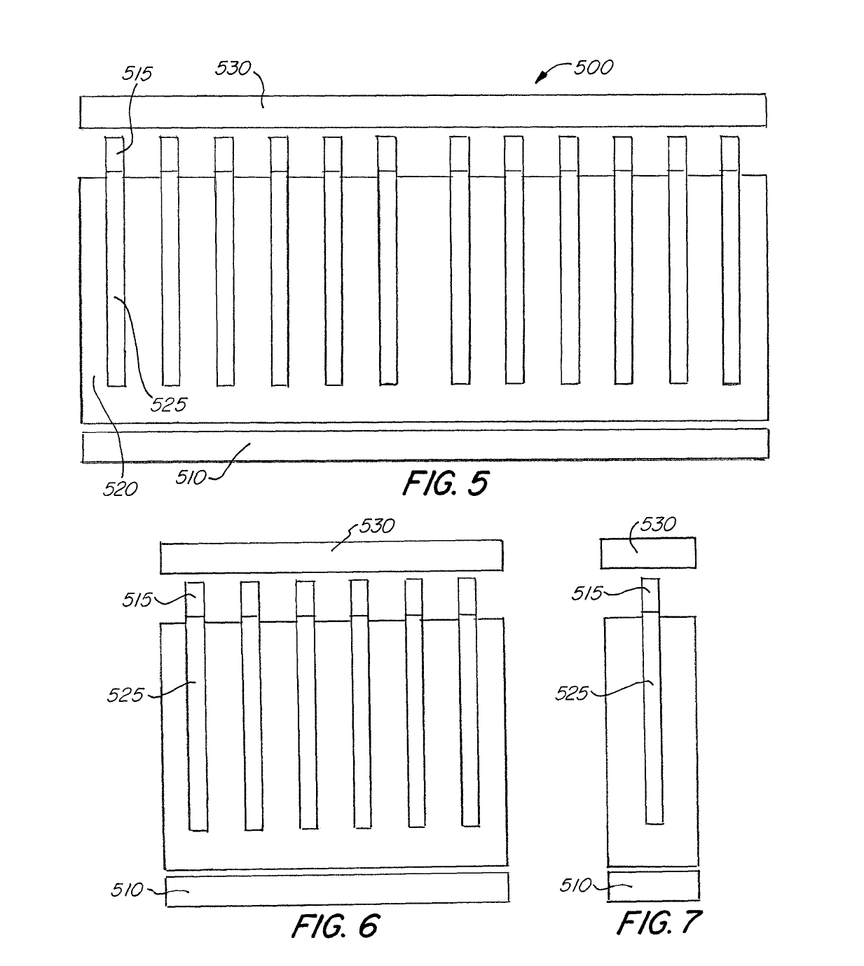

FIG. 5 is a front view of a DSC calorimeter 500. The DSC calorimeter 500 has twelve slots or ports 525, which are within a temperature controlled block 520. The slots or ports 525 have insertion caps 515. Also shown are user interface area & fluidics loading 530 and an electrical, control and communications interface 510.

The DSC calorimeter 500 is able to receive MEMS cassettes 100 or 400 and/or dummy cassettes in the ports or slots. The DSC calorimeter 500 is able to conduct experiments on the MEMS cassettes located within the slots.

FIG. 6 is a front view of a DSC calorimeter having six slots or ports. FIG. 7 is front view of a DSC calorimeter having one slot or port. The DSC calorimeters have one, six or twelve slots or ports are able to receive MEMS cassettes as shown in FIGS. 1-4.

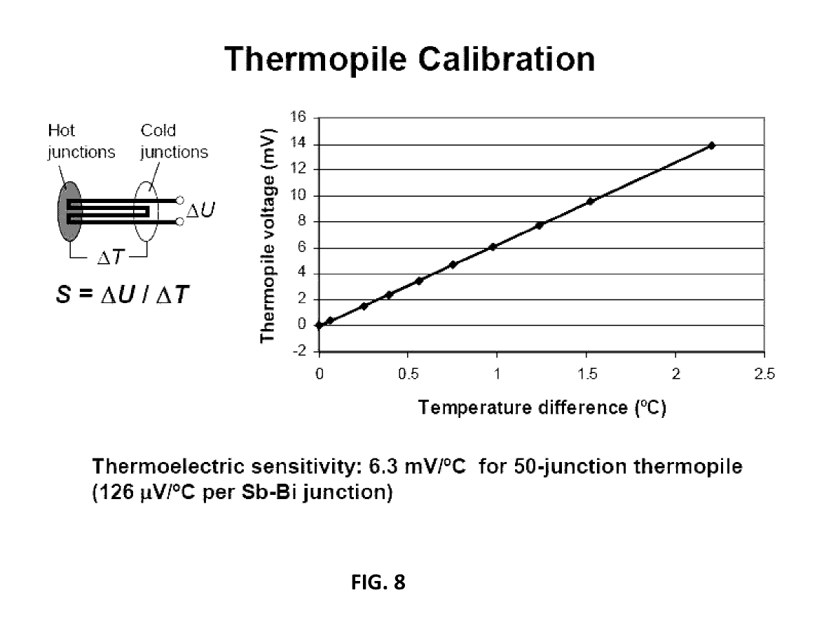

FIGS. 8-12 are plots showing various experimental results using the MEMS cassette.

FIG. 8 is a plot showing the thermopile voltage (mV) v. temperature difference (° C.) for the calibration of a thermopile. The plot shows thermoelectric sensitivity for a 50-junction thermopile and shows that as the temperature difference between the reference and sample cell increase, the thermopile voltage increases linearly as well.

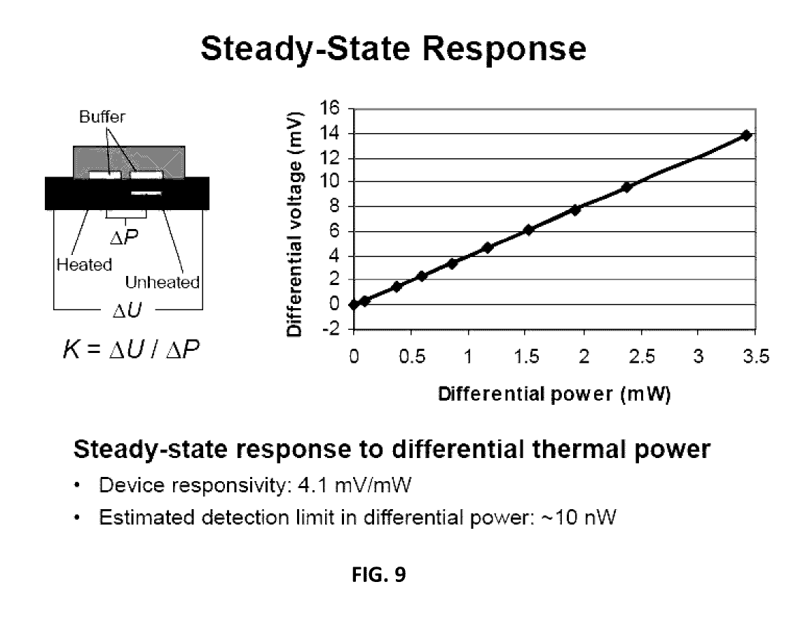

FIG. 9 is a plot showing differential voltage (mV) v. differential power (mW) for a MEMS device. The plot shows that there is a steady-state response to differential thermal power, and as the differential voltage increases, then resulting differential power increases linearly as well.

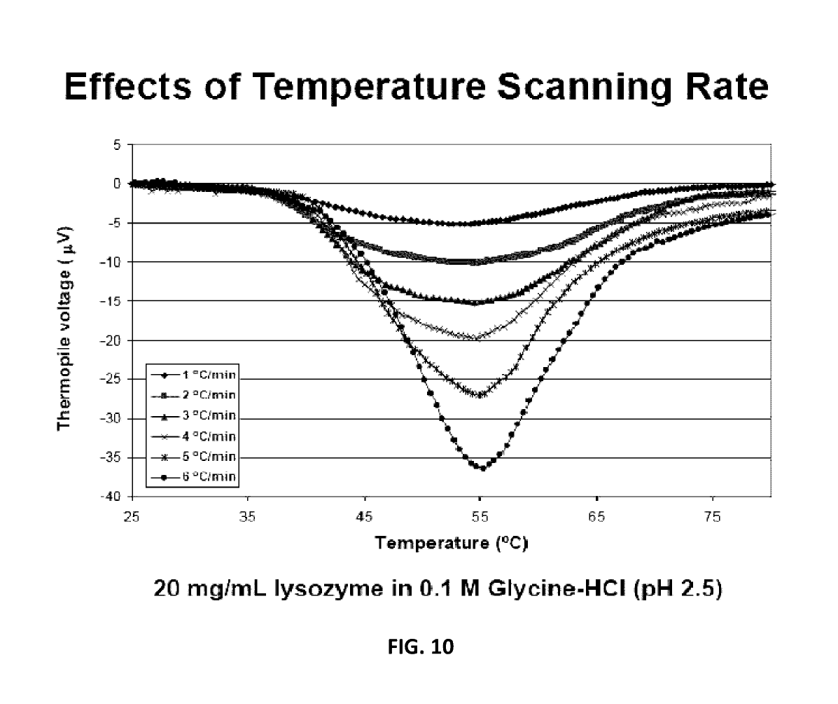

FIG. 10 is a plot showing the effects of temperature on the scanning rate and shows the thermopile voltage (μV) v. temperature (° C.) for a 20 mg/mL lysozyme in 0.1 M Glycine-HCl mixture. The thermopile voltage increases in a set range at 55° C. as the lysozyme denatures.

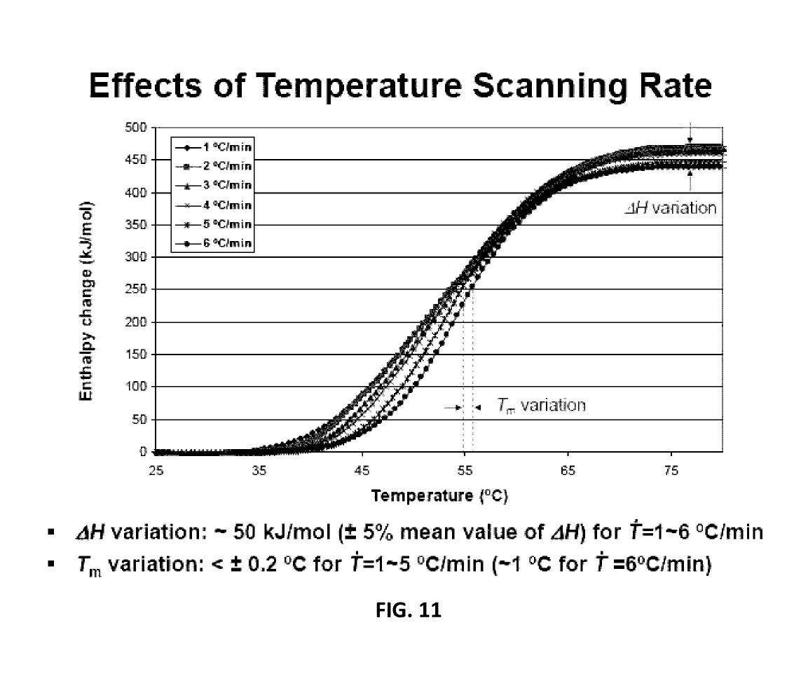

FIG. 11 is a plot showing the effects of temperature on the scanning rate and shows the enthalpy change (kJ/mol) v. temperature (° C.) for the 20 mg/mL lysozyme in 0.1 M Glycine-HCl mixture of FIG. 10. The greatest amount of enthalpy changes at 55° C., which indicates that the lysozyme denatures and gives off heat.

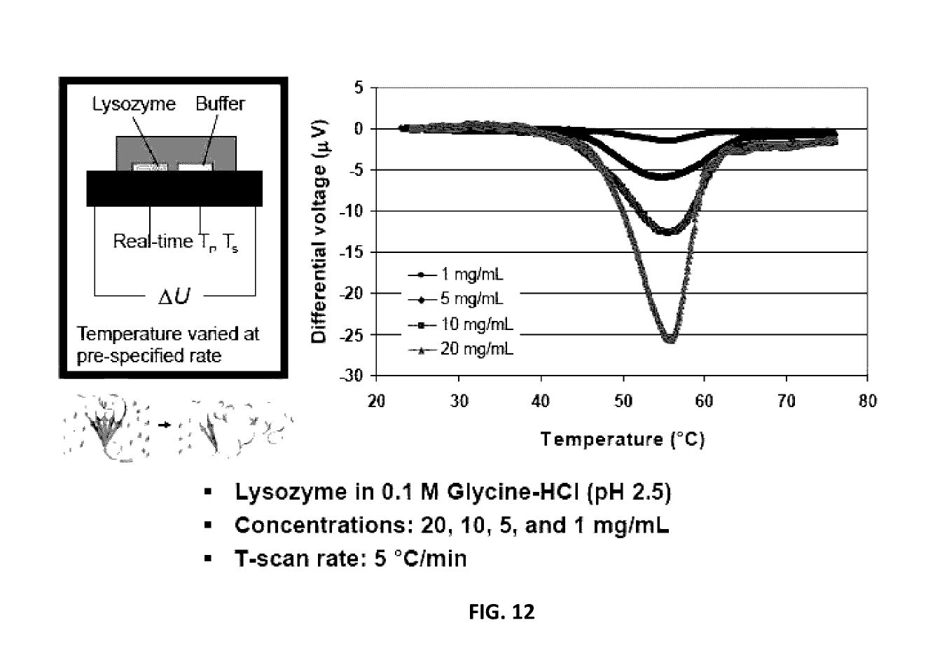

FIG. 12 is a plot showing the differential voltage v. temperature (° C.) for different concentrations of lysozyme in a 0.1 M Glycine-HCl mixture. As the concentration of lysozyme increases, the amount of differential voltage generated increases.

While the invention has been specifically described in connection with certain specific embodiments thereof, it is to be understood that this is by way of illustration and not of limitation and that various changes and modifications in form and details may be made thereto, and the scope of the appended claims should be construed as broadly as the prior art will permit.

The description of the invention is merely exemplary in nature, and thus, variations that do not depart from the gist of the invention are intended to be within the scope of the invention. Such variations are not to be regarded as a departure from the spirit and scope of the invention.

What is claimed is:

1. A MEMS cassette for insertion into a DSC calorimeter comprising:
a housing; and
a chip mounted within the housing, the chip including:
a first channel extending through the chip;
a second channel extending through the chip;
a first reaction area located within the first channel;
a second reaction area located within the second channel;
a thermopile configured to convert thermal energy from the first reaction area and the second reaction area into electrical energy, and
at least one heating element, the at least one heating element configured to provide localized heat to the first and second reaction areas to generate a reaction of at least one sample located within the first reaction area and the second reaction area.

2. The MEMS cassette of claim 1, wherein the at least one heating element includes four individual heating elements.

3. The MEMS cassette of claim 1, wherein the housing is made of an outer plastic shell.

4. The MEMS cassette of claim 1, wherein the cassette is configured to be electronically plugged into the DSC calorimeter.

5. The MEMs cassette of claim 4, wherein the cassette is in electrical connection with the DSC calorimeter.

6. The MEMs cassette of claim 1, wherein the cassette is scanned by the DSC calorimeter.

7. The MEMS cassette of claim 1, wherein the cassette is disposable.

8. The MEMS cassette of claim 1, wherein the cassette housing comprises four channels.

9. The MEMS cassette of claim 8, wherein the four channels of the cassette are each in separate communication with a first inlet, second inlet, first outlet and second outlet in the MEMS chip, so that the four channels can transfer fluid into the first inlet and the second inlet and out of the first outlet and the second outlet.

10. The MEMS cassette of claim 1, further comprising a thermal interface, the thermal interface connected to the thermopile, so that the thermal interface measures the amount of electrical energy generated by thermopile.

11. The MEMS cassette of claim 1, wherein the first reaction area has a larger surface area than the first channel and the second reaction area has a larger surface than the second channel.

12. The MEMS cassette of claim 1, wherein the cassette housing has tapered edges at its distal end.

13. The MEMS cassette of claim 1, wherein the cassette housing is substantially rectangular.

14. The MEMS cassette of claim 1, wherein a chemical dye is inserted into the first and the second reaction area, such that the fluorescence of the chemical dye is measured.

15. The MEMS cassette of claim 1, wherein the cassette housing is substantially rectangular and having a length of 11.0 mm to 32.0 mm and a width of 20.0 mm to 24.00 mm.

16. A DSC calorimeter comprising:
an instrument block;
a temperature scanning unit;
an electrical interface; and
at least one MEMS cassette for insertion into a DSC calorimeter having
a housing; and
a chip mounted within the housing, the chip including:
a first channel extending through the chip;
a second channel extending through the chip;
a first reaction area located within the first channel;
a second reaction area located within the second channel;
a thermopile configured to convert thermal energy from the first reaction area and the second reaction area into electrical energy, and
at least one heating element, the at least one heating element configured to provide localized heat to the first and second reaction areas to generate a reaction of at least one sample located within the first reaction area and the second reaction area,
wherein the at least one MEMS cassette is inserted into the instrument block and is in communication with said temperature scanning unit and said electrical interface.

17. The DSC calorimeter of claim 16, wherein the instrument block includes twelve ports, wherein each of the twelve ports is configured to receive one of the at least two MEMS cassettes.

18. The DSC calorimeter of claim 17, wherein there are twelve MEMS cassettes.

19. The DSC calorimeter of claim 17, further comprising dummy cassettes, the dummy cassettes configured to be inserted into each of the twelve ports.

20. The DSC calorimeter of claim 19, wherein the dummy cassettes are inserted into ports that are unoccupied by said MEMS cassettes.
